(19) United States
(12) Patent Application Publication
(10) Pub. No.: US 2003/0111325 A1
(43) Pub. Date: Jun. 19, 2003

(54) Portable sushi counter with conveyor belt

(76) Inventor: Foo kia Hee, Meragi Road (SG)

Correspondence Address: Laurence S Roach, Jaeckle Fleischmann & Mugel, Suite 200, 39 State Street, Rochester, NY, 14614-1310, US

(21) Appl. No.: 10/203,680

(22) PCT Filed: Jan. 31, 2001
(86) PCT No.: PCT/SG01/00015

(30) Foreign Application Priority Data
Feb. 11, 2000 (SG) 200000779-9

(51) Int. Cl. B65G 21/00

(52) U.S. Cl. 198/860.3

(57) ABSTRACT

The present portable food or sushi counter (1) comprises a table top (3) forming a perimeter around said food counter, the table top (3) being formed from a plurality of sections; a conveyor belt assembly (5) forming an inner perimeter around an inner portion of said food counter, the conveyor belt assembly (5) being formed from a plurality of sections; a first mechanism for easily mating said sections together; a set of legs (9) supporting said food counter; and a second mechanism for easily mating said legs to said sections.

### FIELD OF THE INVENTION

The present invention relates generally to the field of restaurant equipment, and particularly to a portable sushi counter with a conveyor belt.

### BACKGROUND OF THE INVENTION

A patron of Japanese food has surely seen and sat at a sushi counter with a conveyor belt system. The conveyor belt carries various types of sushi-type dishes as it travels along the counter top in a closed loop. Typically, the conveyor belt moves through the kitchen such that the sushi dishes can be replenished as they are taken by the restaurant patrons that sit along the perimeter the of the sushi counter. A hollowed area is provided in the middle of the counter. The area is big enough for a sushi chef to move about and serve the customers that order dishes which are not found on the conveyor belt.

The sushi counter with a conveyor belt is a convenient and interesting way to serve sushi-type of foods. It is good for the customers as they are treated with a variety of dishes without having to frequently call for a waiter. Since the dishes are ready and available, very little waiting is required. It is also good for the restaurant owner as few waiters and waitress are needed when such counters are used. By rotating the conveyor belt, the customers can access all of the dishes at the comfort of their own seat, a distinct advantage from the conventional buffets. In addition, the conveyor belt allows every customer to have equal access to the food.

Although the advantages of a sushi counters with a conveyor belt can easily be appreciated, currently, such counters are only available at the restaurants. Yet, the advantages of such counters can be utilized in banquets, parties, and other gatherings which occur outside of such restaurants. However, at the present moment, there is no easy and effective way to provide such a counter outside of the restaurants.

### OBJECTS OF THE INVENTION

It is therefore an object of the present invention to provide a portable sushi counter with conveyor belt which can be easily transported to events outside of the restaurants.

It is another object of the present invention to provide a portable sushi counter with conveyor belt which is modular in design.

It is another object of the present invention to provide a portable sushi counter with conveyor belt which can be easily assembled and disassembled.

It is another object of the present invention to provide a portable sushi counter with conveyor belt which is simple in design.

It is another object of the present invention to provide a portable sushi counter with conveyor belt which when disassembled takes up minimal amount of space.

### SUMMARY OF THE INVENTION

The present portable food or sushi counter comprises a table top forming a perimeter around said food counter, the table top being formed from a plurality of sections; a conveyor belt assembly forming an inner perimeter around an inner portion of said food counter, the conveyor belt assembly being formed from a plurality of sections; a first mechanism for easily mating said sections together; a set of legs supporting said food counter; and a second mechanism for easily mating said legs to said sections. In the preferred embodiment, the center portion of the sushi counter is hollowed such that a person such as a sushi chef, if needed, may stand and move about to prepare new dishes and place them onto the conveyor belt.

The conveyor belt assembly includes a main body which provides the support for the assembly. Within the main body are rails which directly support the conveyor belt. Four rotatable discs are provided at each comer of the assembly to facilitate the movement of the conveyor belt. The movement of the conveyor belt is powered by a motor.

The sushi counter is modular in design as it is formed from a plurality of sections which can be easily assembled and disassembled. Each of the sections has a bottom side with a rigid support system which provides strength to the section. The bottom side further has receiving blocks for mating with the legs. In the preferred embodiment, the legs are self-standing legs which can be folded for easy transport.

### BRIEF DESCRIPTION OF THE DRAWINGS

FIG. 1 illustrates the present portable sushi counter in its assembled configuration.

FIG. 2 illustrates the portable sushi counter of FIG. 1 with the conveyor belt and legs removed.

FIG. 3 illustrates the bottom side of a comer section of the present portable sushi counter.

FIG. 4 illustrates the bottom side of the comer section shown in FIG. 3 with the legs in place.

FIG. 5 illustrates the bottom side of a middle section of the present portable sushi counter.

FIG. 6 illustrates the bottom side of the middle section shown in FIG. 5 with the legs in place.

FIG. 7 illustrates the legs of the comer section in its unfolded position.

FIG. 8 illustrates the legs of the corner section in its folded position.

FIG. 9 illustrates the present portable sushi counter with the sections disengaged from each other.

FIG. 10 illustrates the comer section with a motor attached below.

### DETAILED DESCRIPTION OF THE INVENTION

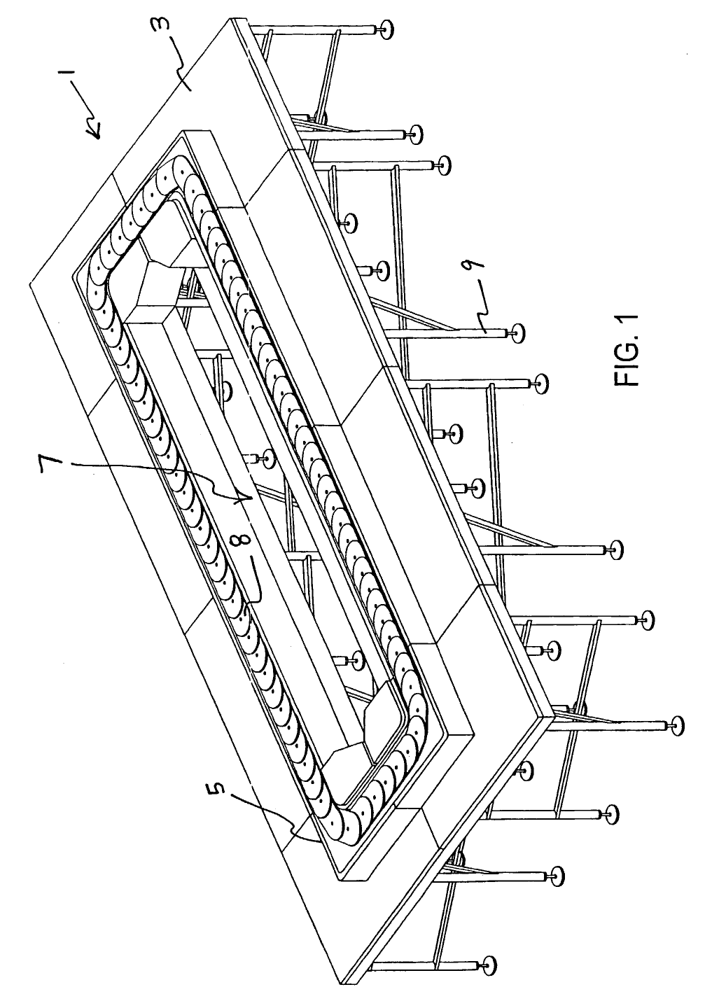

FIG. 1 illustrates the preferred embodiment of the present invention. Referring to FIG. 1, the present portable sushi counter 1 includes a table top 3 which forms a perimeter of the sushi counter 1. The table top 3 provides the eating space for the dining guests sifting around the perimeter (dining guests not shown). Forming an inner perimeter on the inner portion of the sushi counter 1 is an conveyor belt assembly 5 with a conveyor belt 8 in place. Foods such as sushi dishes are placed on the conveyor belt 8 which continually rotates around in a closed loop to give every dining guest access to each of the dishes.

Still referring to FIG. 1, in the preferred embodiment, the center portion 7 of the sushi counter 1 hollowed such that a person such as a sushi chef, if needed, may stand and move about to prepare new dishes and place them onto the conveyor belt 8. However, the center portion, while convenient to have, may not be necessarily in some situations since it is entirely possible to prepare the dishes at another location and simply place them onto the conveyor belt without having a sushi chef being inside the center portion. In such an arrangement, the center portion need not be hollow. The legs 9 are placed underneath the sushi counter 1 to provide support for the sushi counter

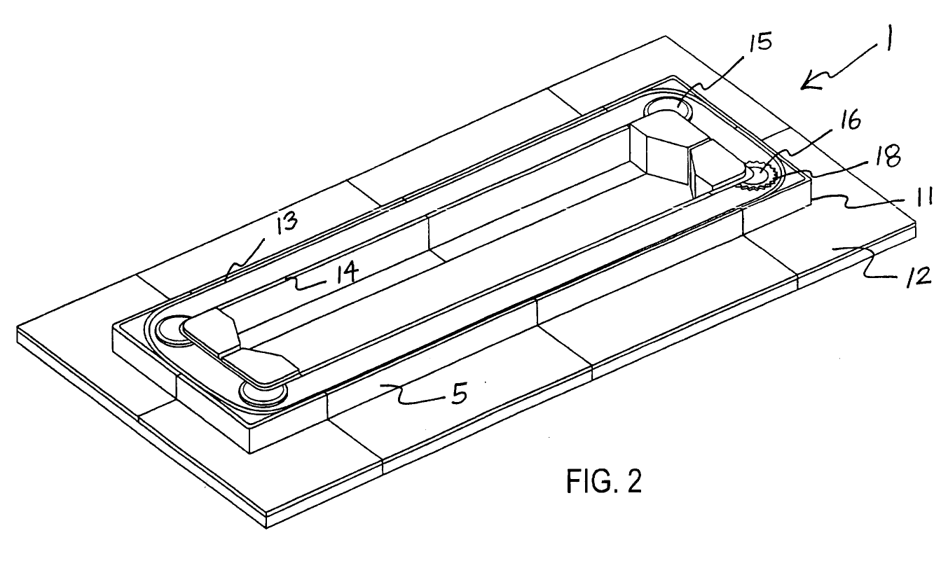

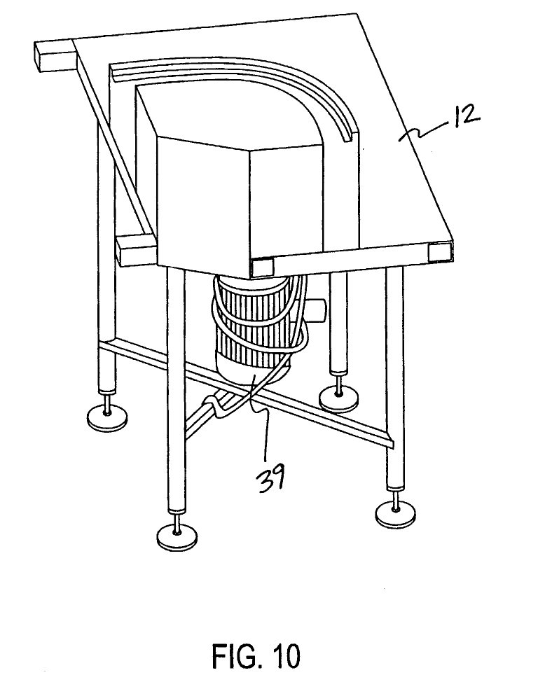

Now referring to FIGS. 1 and 2, the present sushi counter 1 is shown with the conveyor belt 8 removed from the conveyor belt assembly 5 such that the details of the conveyor belt assembly 5 can be better shown. As shown in FIG. 2, the conveyor belt assembly 5 includes a main body 11 which provides the support for the assembly 5. Within the main body 11 are rails 13 and 14 which directly support and guide the conveyor belt 8. The conveyor belt 8 is driven by the sprocket 16 having teeth 18 which are mated with the corresponding teeth (not shown) on the bottom side of the conveyor belt. The sprocket 16 is powered by a motor 39 which is located under the comer piece 12 immediately below the sprocket 16, as shown in FIG. 10. The other three rotatable discs 15 without any teeth are provided at each comer of the assembly 5 to facilitate a smooth movement of the conveyor belt.

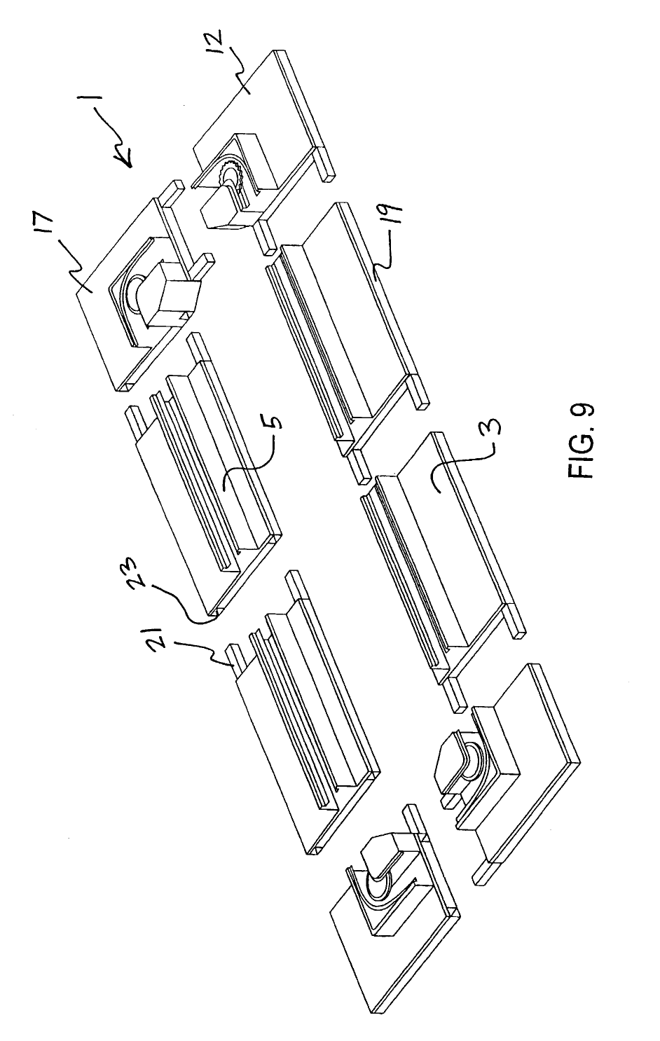

The sushi counter 1 shown in FIG. 1 is modular in design as it is formed from a plurality of sections which can be easily assembled and disassembled, as shown in FIG. 9. Although the sectioning can be done in many shapes and sizes, in the preferred embodiment, the sections are divided into two types: the comers 17 and the middle pieces 19. To make the pieces easier to manufacture, all the comer pieces are generally the same in design and sizes, and all of the middle pieces are also generally the same in design and sizes. To be able to easily mate each the sections together, each of the sections are provided with a first mechanism which includes a pair of dowel pins 21 which are fittingly mated with the corresponding holes 23. For ease of assembly, in the preferred embodiment, each of the sections contains both the table top portion 3 as well as the conveyor belt assembly portion 5, though it is possible to have the table top and the conveyor belt assembly as separate sections.

By having the sushi counter 1 and its the sections generally symmetrical, it is possible to change the size and shape of the sushi counter 1. For instance, if one were to want a longer counter, one simply needs to add a set of additional middle pieces between the middle sections 19 already present. If, however, one were to want a wider counter, then one simply needs to add additional set of middle pieces between the comer sections 17. One can both widen and elongate the sushi counter 1 by adding the additional middle sections in both places. Similarly, the sushi counter 1 may be made smaller simply by removing a set of the existing middle sections 19. Of course, the conveyor belt assembly 5 should be set such that the rails 13 and 14 are always properly aligned regardless of the configuration.

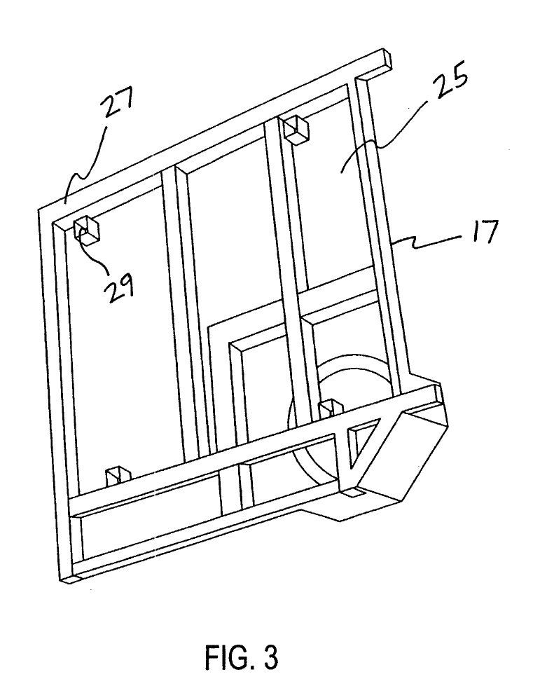

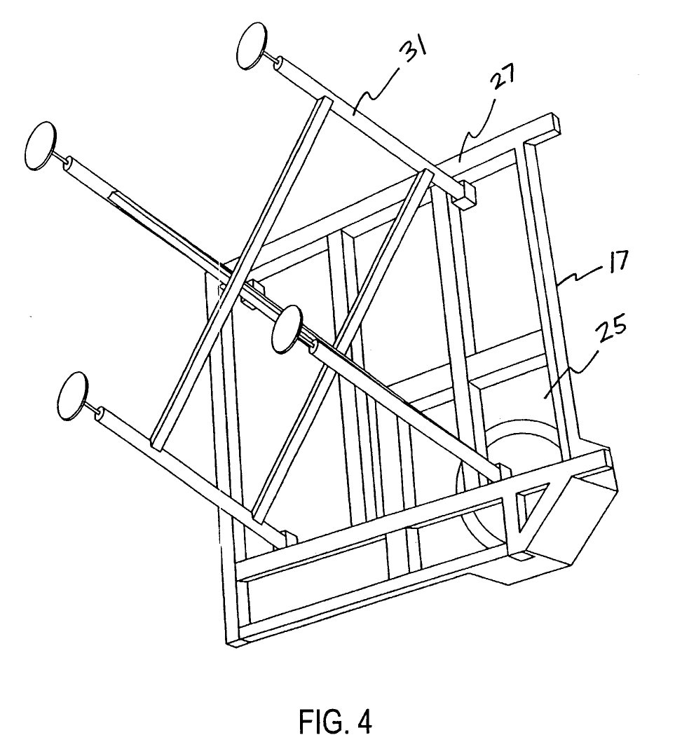

Now referring to FIG. 3, the bottom side 25 of a comer section 17 is shown. As can be seen from FIG. 3, the bottom side 25 has a rigid support system 27 which provides strength to the section 17. The bottom side 25 further has receiving blocks 29 for mating with the legs 31 as shown in FIG. 4. The legs 31 are easily mated with said bottom side 25 of said comer sections 17 by simply placing the legs into said receiving blocks 29. The legs 31 are easily removed from said sections by simply pulling the legs 31 out from the receiving blocks 29.

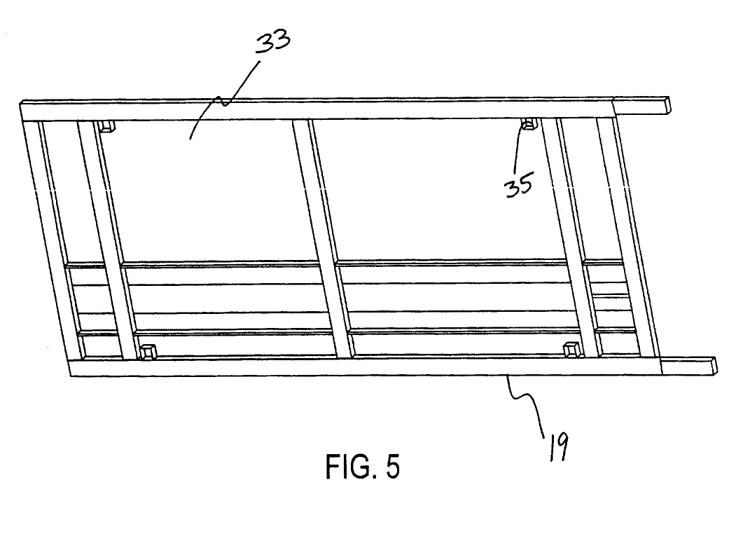

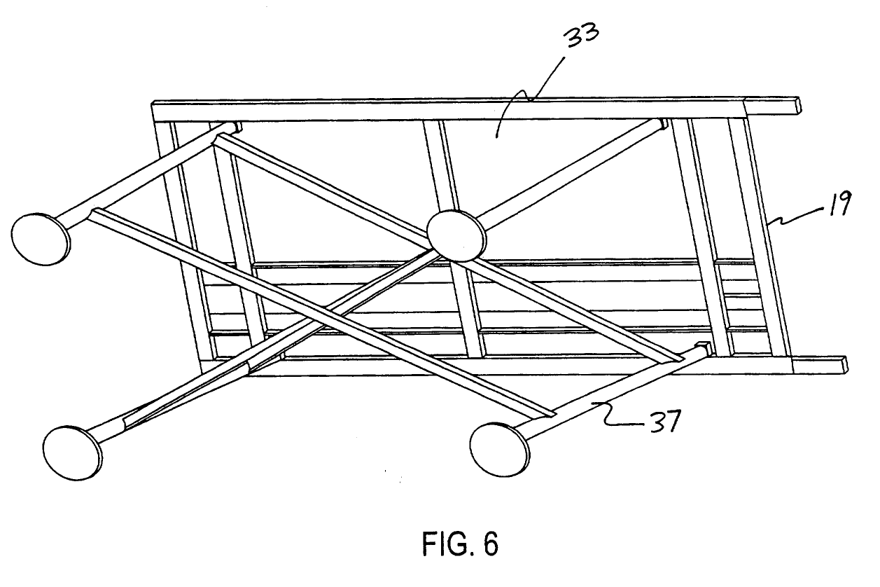

Now referring to FIG. 5, the bottom side 33 of a middle piece 19 is shown. Similar to the comer sections 17, the bottom side 33 of the middle piece 19 also has a rigid support system 35 which provides strength to the section 19. The bottom side 33 further has a second mechanism for easily mating with the legs which comprises receiving blocks 35 for mating with the legs 37 as shown in FIG. 6. The legs 37 are easily mated with said bottom side 33 of said middle sections 19 by simply placing the legs 37 into said receiving blocks 35. The legs 37 are easily removed from said sections 19 by simply pulling the legs 37 out from the receiving blocks 35.

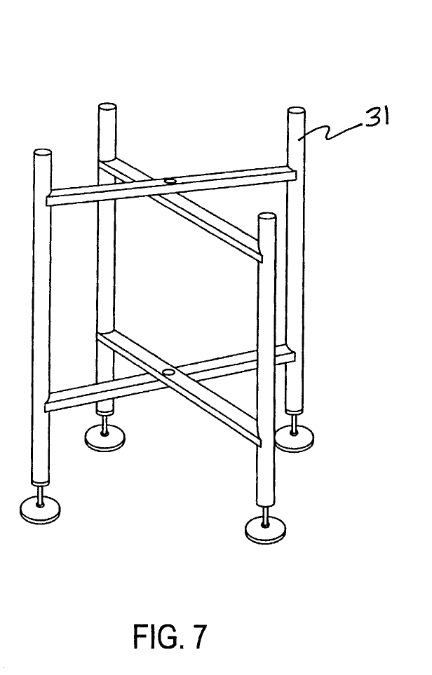

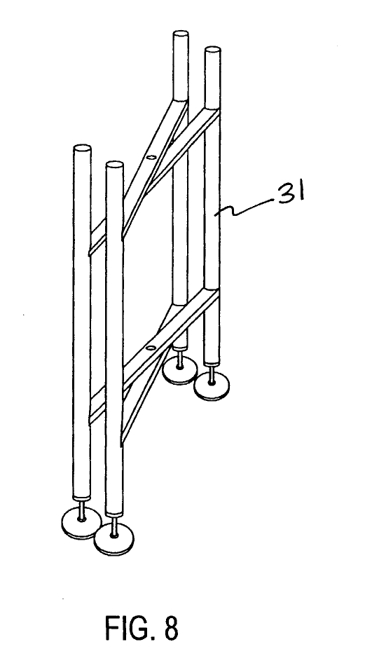

In the preferred embodiment, the legs 31 and 37 are self-standing legs which can be folded for easy transport. FIG. 7 shows the legs 31 in isolation in their opened position, and FIG. 8 shows the same legs 31 in isolation in their folded position. Although not shown, the legs 37 generally have the same design as legs 31, and can be folded in a similar fashion as shown in FIG. 8.

The present invention may be embodied in other specific forms without departing from the spirit or essential characteristics thereof. For instance, although the present invention is made in reference to sushi dishes, it is to be understood that any similar types of food dishes may be placed onto the conveyor belt. Also, although in describing the preferred embodiment many specific designs were shown, it should be understood that other types of designs are possible. The presently disclosed embodiments are, therefore, to be considered in all respects as illustrative and not restrictive, the scope of the invention being indicated by the appended claims and all changes which come within the meaning and range of equivalency of the claims are, therefore, to b e embraced therein.

What claimed is:

1. A portable food counter comprising:
a table top forming a perimeter around said food counter;
a conveyor belt assembly forming an inner perimeter around an inner portion of said food counter, said table top and said conveyor belt assembly being formed from a plurality of sections;
a first mechanism for ease of mating of said plurality of sections together;
said first mechanism allowing for ease of assembly and disassembly of said plurality of sections;
a set of legs supporting said plurality of sections;
a second mechanism for easily mating said legs to said plurality of sections, and said second mechanism allowing for ease of assembly and disassembly of said set of legs to said plurality of sections.

2. The portable food counter as recited in claim 1 wherein said conveyor belt assembly comprises:
a conveyor belt;
a main body;
a set of rails on said main body for supporting and guiding said conveyor belt;
a sprocket for driving said conveyor belt;
a set of discs for facilitating a movement of said conveyor belt; and
a motor connected to said sprocket for powering said movement.

3. The portable food counter as recited in claim 1 wherein said sections include both said table top and said conveyor belt.

4. The portable food counter as recited in claim I wherein said first mechanism comprises a set of dowel pins and corresponding holes.

5. The portable food counter as recited in claim 1 wherein said second mechanism comprises a set of receiving blocks for receiving said legs, said receiving blocks being located on a bottom side of said sections.

6. The portable food counter as recited in claim 1 wherein said legs are self-standing and foldable.

7. The portable food counter as recited in claim 1 wherein a center portion as defined by an inner portion of said inner perimeter is hollow.

8. The portable food counter as recited in any of the preceding claims wherein said sections include both said table top and said conveyor belt.

9. The portable food counter as recited in any of the preceding claims wherein said first mechanism comprises a set of dowel pins and corresponding holes.

10. The portable food counter as recited in any of the preceding claims wherein said second mechanism comprises a set of receiving blocks for receiving said legs, said receiving blocks being located on a bottom side of said sections.

11. The portable food counter as recited in any of the preceding claims wherein said legs are self-standing and foldable,

12. The portable food counter as recited in any of the preceding claims wherein a center portion as defined by an inner portion of said inner perimeter is hollow.

13. The portable food counter as recited in any of the preceding claims wherein said food counter is generally symmetrical in shape.

14. A portable food counter comprising:
a set of corner sections, each corner section having a table top and a conveyor belt assembly;
a set of middle sections set in between said set of corner sections, each middle section having a table top and a conveyor belt assembly;
a first mechanism for easily mating said set of comer sections and said middle sections together, said first mechanism allowing for ease of assembly and disassembly of said set of corner sections and said set of middle sections;
a set of legs supporting said set of corner sections and said set of middle sections, and
a second mechanism for easily mating said set of legs to said set of corner sections and said set of middle sections, said second mechanism allowing for ease of assembly and disassembly of said set of legs to said plurality of sections.

15. The portable food counter as recited in claim 14 wherein said food counter may be expanded by inserting a set of additional middle sections in between said middle sections.

16. The portable food counter as recited in claim 14 wherein said food counter may be expanded by inserting a set of additional middle sections in between said corner sections.

17. The portable food counter as recited in claims 14 through 16 wherein said conveyor belt assembly comprises:
a conveyor belt;
a main body;
a set of rails on said main body for supporting and guiding said conveyor belt;
a sprocket for driving said conveyor belt;
a set of discs for facilitating a movement of said conveyor belt; and
a motor connected to said sprocket for powering said movement.

18. The portable food counter as recited in claims 14 through 17 wherein said sections include both said table top and said conveyor belt.

19. The portable food counter as recited in claims 14 through 17 wherein said first mechanism comprises a set of dowel pins and corresponding holes.
